(19) United States
(12) Patent Application Publication
(10) Pub. No.: US 2025/0026091 A1
(43) Pub. Date: Jan. 23, 2025

(54) METHOD FOR MANUFACTURING A BLADE, IN PARTICULAR A COMPOSITE BLADE

(71) Applicant: SAFRAN AIRCRAFT ENGINES, Paris (FR)

(72) Inventors: Mattéo MINERVINO, Moissy-Cramayel (FR); Nicolas DROZ, Moissy-Cramayel (FR); Thierry Claude Henri GODON, Moissy-Cramayel (FR); Hervé GRELIN, Moissy-Cramayel (FR)

(73) Assignee: SAFRAN AIRCRAFT ENGINES, Paris (FR)

(21) Appl. No.: 18/715,270

(22) PCT Filed: Nov. 23, 2022
(86) PCT No.: PCT/FR2022/052158

§ 371 Date: May 31, 2024

(30) Foreign Application Priority Data
Dec. 2, 2021 (FR) FR2112847

(51) Int. Cl. B29C 70/48; B29C 70/72; B29D 99/00

(52) U.S. Cl. CPC B29C 70/48; B29C 70/72; B29D 99/0025

(57) ABSTRACT

A method including the preparation of a spar preform arranged in a first mould, the spar preform including a core and a root; a first injection step of a first thermosetting resin in the spar preform; partial polymerization of the first resin in the spar preform until partial vitrification of the first thermosetting resin; positioning a body preform around the core of the spar preform; injection of a second resin into the blade body preform; and complete polymerization of the first and second resin.

### TECHNICAL FIELD

The disclosed invention relates to the manufacture of a blade, in particular a composite blade such as a blade for a turbine engine, in particular a turbojet engine.

### PRIOR ART

Composite materials are increasingly more used in aeroengines to reduce the mass of the structures whilst ensuring good mechanical performance.

To improve engine performance, and particularly aeronautic thrust and performance requirements, parts in composite material have geometries of ever greater complexity.

A method is known from patent application FR2985940, for the manufacture of a propeller blade in composite material. This method comprises the insertion of a spar with a first polymerized resin in a blade preform, and the injection of a second resin in the blade preform.

However, the mechanical strength at the interface between the spar and the blade preform may not be satisfactory.

### DESCRIPTION OF THE INVENTION

The disclosed invention sets out fully or partly to remedy this disadvantage.

For this purpose, it relates to a method for manufacturing a blade, in particular a composite blade, comprising at least:
a preparation step, at which a spar preform having at least one core, in particular a fibre-containing spar preform, is arranged in a first mould;
a first injection step, at which a first resin, in particular a thermosetting first resin, is injected into the spar preform;
a partial polymerization step, at which polymerization of the first resin in the spar preform is conducted until partial vitrification of the first resin;
a positioning step, at which a preform of a blade body, in particular a fibre-containing preform of a blade preform is positioned around the core of the spar preform;
a second injection step at which a second resin, in particular a thermosetting second resin is injected into the preform of the blade body; and
a complete polymerization step, at which final polymerization of the first resin and second resin is performed.

By partially polymerizing the first resin in the spar preform until partial vitrification of the first resin, the spar preform can be handled in particular for positioning thereof in the preform of the blade body.

Partial vitrification of the first resin therefore imparts sufficient stiffness to the spar so that it does not deform beyond a non-permissible level at the time of mould release and insertion in the preform of the blade body, and also low tack to prevent the spar remaining glued to the mould and/or attaching to any surface with which it may come into contact.

In addition, the vitrification of the first resin being partial, at the time of complete polymerization the first resin and second resin are able to bind together and thereby form an interface having better mechanical properties than when the first resin is fully polymerized before injection of the second resin.

It is therefore possible to obviate additional steps of applying an adhesive, bonding paste and/or bonding primer to the spar of which the resin has been fully polymerized. The manufacturing steps are thus reduced together with costs related to the bonding material which are non-negligible. The risk is also reduced of non-conforming bonding between the spar and the blade body, which can go as far as scrapping of the part for non-conformity with specifications.

It will be understood that the injection of the first resin and of the second resin is performed in a first and second mould respectively.

As nonlimiting examples, injection is performed by closed mould resin injection also known as Liquid Composite Moulding (LCM), for example by Resin Transfer Moulding (RTM), by Vacuum Assisted Resin Transfer Moulding (VA-RTM) or by Compressive Resin Transfer Moulding C-RTM).

In one example of embodiment, the fibre-containing preform of the blade body may comprise a first portion formed of fibres and a fibre-free second portion.

As nonlimiting example:
the second portion, free of fibres, can be formed of a foam; and/or
the fibre-containing spar preform can be a 3D weave; and/or
the fibre-containing preform of the blade body can at least be partially a 3D weave.

In some embodiments, the first resin and/or second resin is a thermosetting resin via polyaddition.

Alternatively, it can be envisaged in some embodiments that the first resin and/or second resin is a thermosetting resin via polycondensation. However, preferably, the partial polymerization step of the first resin is performed via polyaddition. This avoids the generating of volatile compounds, water in particular, that are difficult to evacuate. Said volatile compounds are likely to create a porous part having mechanical characteristics below expectations.

According to various characteristics of the invention:
the first resin and second resin can be epoxy resins; and/or
the first resin and the second resin can be the same; and/or
partial polymerization of the first resin can be conducted until a degree of crosslinking is obtained higher than or equal to 0.5, preferably higher than or equal to 0.6, more preferably higher than or equal to 0.7; and/or
the temperature of partial polymerization of the first resin can be lower than the nominal polymerization temperature of the first resin.

The temperature of partial polymerization of the first resin being lower than the nominal polymerization temperature of the first resin, it is possible to reduce the polymerization rate of the first resin and thereby more precisely control the progress of polymerization (gelling and vitrification).

As nonlimiting example, the temperature of partial polymerization of the first resin can be 20° C. lower (degrees Celsius) than the nominal polymerization temperature of the first resin.

In some embodiments, the nominal polymerization temperature of the second resin can be higher than or equal to the nominal polymerization temperature of the first resin. In particular, the difference between the nominal polymerization temperature of the second resin and the nominal polymerization temperature of the first resin can be lower than or equal to 20° C.

It is therefore possible to reduce, and even prevent, potential devitrification of the first resin at the complete polymerization step of the first resin and second resin.

### BRIEF DESCRIPTION OF THE DRAWINGS

Other characteristics and advantages of the subject of the present disclosure will become apparent from the following description of embodiments given as nonlimiting examples, with reference to the appended Figures.

FIG. 1 is a flow diagram giving the steps of a method for manufacturing a blade, in particular a composite blade, of the invention; and

FIG. 2 is a cross-sectional view of a blade, in particular a composite blade.

### DETAILED DESCRIPTION

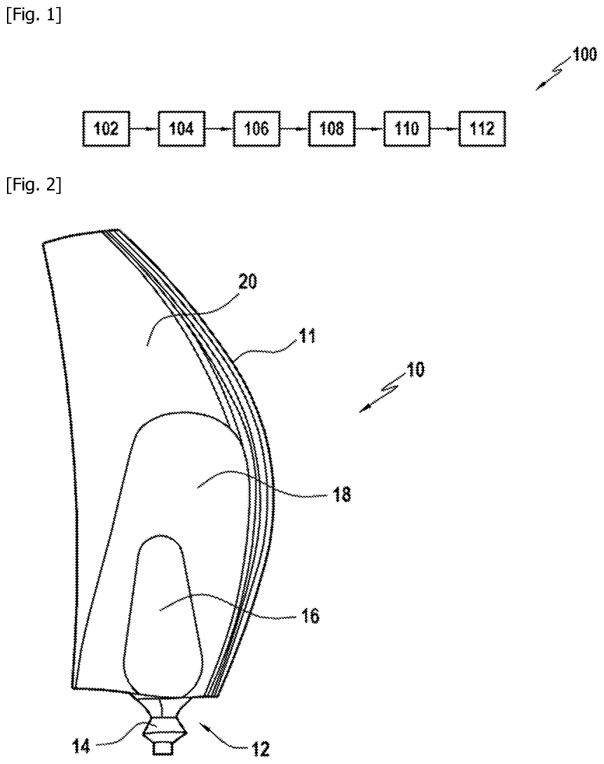

FIG. 1 is a flow diagram giving the steps of a method 100 for manufacturing a blade 10, in particular a composite blade 10. In the example shown in FIG. 2, the blade 10 can be a variable pitch fan blade.

The blade 10 comprises a spar 12 and a blade body 11. The spar 12 comprises a root 14 and a core 16. The blade body 11 comprises a first portion 20 and a second portion 18.

In the embodiment in FIG. 2, the root 14 is also called a «tulip root» and allows the blade 10 to be held in position whilst allowing rotation of the blade 10 about the blade axis.

In one particular embodiment, a preform of the spar 12 of the blade 10 is composed of a 3D weave. The spar 12 can also be a laminate, via the stacking of unidirectional dry fabrics, the stacking of braided materials and/or of wound or laminated 2D fabrics, prepared by manual or automatic positioning also known as Automatic Fiber Placement (AFP).

As nonlimiting examples, the fibres of the preform of the spar 12 can be carbon fibres, glass fibres, Kevlar fibres and/or polyester fibres.

In the embodiment in FIG. 2, the preform of the first portion 20 of the body 11 of the blade can be formed of a 3D weave. The first portion 20 of the body 11 of the blade 10 can also be formed of a laminate, by stacking of unidirectional dry fabrics, stacking of braided materials and/or of wound or laminated 2D fabrics, obtained by manual or automatic positioning also known as Automatic Fiber Placement (AFP).

As nonlimiting examples, the fibres of the preform of the first portion 20 of the body 11 of the blade 10 can be carbon fibres, glass, fibres, Kevlar fibres and/or polyester fibres.

In one particular embodiment of FIG. 2, the preform of the second portion 18 of the body 11 of the blade 10 can be formed of a foam.

As nonlimiting example, the second portion 18 of the body 11 of the blade 10 can be formed of an open cell foam.

In one particular embodiment of FIG. 2, the first portion 20 of the body 11 of the blade 10 is arranged around the second portion 18 of the body 11 of the blade 10. Also, the second portion 18 of the body 11 of the blade 10 may comprise a housing intended to receive the spar 12.

As nonlimiting example, the method 100 for manufacturing the blade 10, in particular the composite blade 10, is described in connection with FIG. 1.

The method 100 for manufacturing the blade 10 comprises at least one preparation step 102 at which the preform of the spar 12 is placed in a first mould. In one variant, the preform of the spar 12 can be formed of 3D woven carbon fibres.

The method 100 for manufacturing the blade 10 also comprises a first injection step 104 at which a first resin, in particular a thermosetting first resin, is injected into the preform of the spar 12.

As nonlimiting examples, the first resin can be an epoxy resin e.g. the resin marketed by Solvay under the trade name PR 520 ®, a polyimide resin such as a polybismaleimide, and/or phthalonitrile resin. Preferably the first resin polymerizes via polyaddition.

The first resin can be preheated, for example to 160° C. Said temperature corresponds to the partial polymerization temperature and is about 20° C. lower than the nominal polymerization temperature of the first resin.

In one particular example, the nominal polymerization temperature is in the region of 180° C., for example 180° C.+/−5° C.

Partial polymerization is conducted at a lower temperature so that the reaction takes place more slowly and can be suitably interrupted.

The method 100 for manufacturing the blade 10 also comprises a partial polymerization step 106 at which polymerization of the first resin contained in the preform of the spar 12 is conducted until partial vitrification of the first resin.

For example, the partial polymerization step 106 of the first resin can be conducted at a temperature of 160° C., in particular for a time of one hour.

As an example, an advantageous result is such that after one hour at 160° C., the first resin has reached a crosslinking degree of 80%.

Thereafter, the preform of the spar 12 with the first resin is removed from the first mould.

The method 100 for manufacturing the blade 10 also comprises a positioning step 108 at which a preform of the body 11 of the blade 10 is positioned around the core 16 of the preform of the spar 12. Advantageously, the preform of the spar 12 comprising the partially polymerized first resin is inserted in the housing to receive the spar 12 in the second portion 18 of the preform of the body 11 of the blade 10.

Positioning can be performed in a second mould. If positioning is performed outside the second mould, the assembly formed by the preform of the spar 12 and the preform of the body 11 of the blade 10 is placed in the second mould.

The method 100 for manufacturing the blade 10 also comprises a second injection step 110 at which a second resin, in particular a thermosetting first resin, is injected into the preform of the body (11) of the blade 10.

The second resin, as nonlimiting examples, can be the resin marketed by Solvay under the trade name PR 520 ®, a polyimide resin such as a polybismaleimide, and/or phthalonitrile resin. Preferably the second resin polymerizes via polyaddition.

The second resin can be preheated, for example to 160° C., before it is injected into the second mould.

The method 100 for manufacturing the blade 10 also comprises a complete polymerization step 112 at which final polymerization of the first resin and second resin is carried out, in particular at a temperature of 180° C., and in particular for a time of at least two hours.

Determination of the temperature and time conditions for the partial polymerization step of the first resin can advantageously be determined by differential scanning calorimetry (DSC). It is thus possible to determine the conversion rate also called degree of crosslinking or degree of polymerization, as a function of temperature for a given resin.

For this purpose, using differential scanning calorimetry, different heat cycles of between 120° C. and 180° C. are tested for times of between 10 minutes and 6 hours. Graphs can then be obtained giving an indication of the progress of a resin as a function of the thermal history thereof. The progress of the resin under complex cycles can therefore be derived from the principles of polymerization.

It is thereby possible to determine the crosslink value e.g. 80%, affording a good compromise between sufficiently low progress so that the resin is able to continue crosslinking under the second heating, and sufficiently high so that the intermediate part is able to be handled without deforming.

Although the invention has been disclosed with reference to a specific example of embodiment, various modifications and changes can evidently be made to these examples without departing from the general scope of the invention such as defined by the claims. In addition, individual characteristics of the different described embodiments can be combined in additional embodiments. The description and drawings must therefore be construed as being illustrative rather than restrictive.

1. A method for manufacturing a blade, in-particular a composite blade, comprising at least:
a preparation step, at which a preform of a spar comprising at least one core, is arranged in a first mould;
a first injection step, at which a first resin is injected into the preform of the spar;
a partial polymerization step, at which polymerization of the first resin in the preform of the spar is conducted until partial vitrification of the first resin;
a positioning step, at which a preform of a body of the blade is positioned around the core of the preform of the spar;
a second injection step at which a second resin is injected into the preform of the body of the blade; and
a complete polymerization step at which final polymerization of the first resin and second resin is performed.

2. The method according to claim 1, wherein the first resin and second resin are epoxy resins.

3. The method according to claim 1, wherein the first resin and second resin are the same.

4. The method according to claim 1, wherein the partial polymerization of the first resin is conducted until a crosslinking ratio is obtained higher than or equal to 0.5, preferably higher than or equal to 0.6, in particular higher than or equal to 0.7.

5. The method according to claim 1, wherein a partial polymerization temperature of the first resin is lower than a nominal polymerization temperature of the first resin.

6. The method according to claim 1, wherein a nominal polymerization temperature of the second resin is higher than or equal to a nominal polymerization temperature of the first resin.

7. The method according to claim 6, wherein a difference between the nominal polymerization temperature of the second resin and the nominal polymerization temperature of the first resin is lower than or equal to 20° C.

8. The method according to claim 1, wherein the blade is a composite blade.

9. The method according to claim 1, wherein the preform of the spar is a fiber-containing preform.

10. The method according to claim 1, where at least one of the first resin and the second resin is a thermosetting resin.

11. The method according to claim 1, wherein the preform of the body of the blade is a fiber-containing preform.
